(19) United States
(12) Patent Application Publication
(10) Pub. No.: US 2019/0276171 A1
(43) Pub. Date: Sep. 12, 2019

(54) TENSIONING MECHANISM

(71) Applicant: Tensionr Holdings, LLC, Roswell, GA (US)

(72) Inventor: Brandon Will, Roswell, GA (US)

(21) Appl. No.: 16/211,065

(22) Filed: Dec. 5, 2018

Related U.S. Application Data
(60) Provisional application No. 62/639,832, filed on Mar. 7, 2018.

(51) Int. Cl. B65B 13/22; B65B 13/18; B65B 13/34; F16H 55/22; F16H 48/00

(52) U.S. Cl. CPC B65B 13/22; B65B 13/187; F16H 48/00; F16H 55/22; B65B 13/34

(57) ABSTRACT

The disclosed technology includes a tensioning mechanism, which can include an input shaft configured to receive torque from a torque source and transmit the torque via a gear assembly to the one or more output gears or shafts such that the one or more output gears or shafts are caused to rotate and output torque.

### CROSS-REFERENCE TO RELATED APPLICATIONS

This application claims priority to, and the benefit under, 35 U.S.C. § 119(e), of U.S. Provisional Patent Application No. 62/639,832, filed 7 Mar. 2018, the entire contents and substance of which are hereby incorporated by reference as if fully set forth below.

### BACKGROUND

Several industries—such as the metal production, lumber, mining, shipping, and construction industries—often use steel strapping or steel banding to bundle loads, such as lumber, steel rods, and other objects for storage and/or shipping. Steel banding, however, can pose a safety risk to workers. For example, steel banding can have sharp or jagged edges, which can result in a cutting hazard to workers or passers-by. Further, even if the steel banding is smoothed and deburred, steel banding can become dangerous for workers during normal use. For example, to bundle a load, a worker must wrap the load with the steel banding and place the steel banding under tension, such as with a steel banding device. If the steel banding is suddenly released during application (e.g., the steel banding slips from the steel banding device), the sudden release of tension may cause a free end of the steel banding to propel into one or more objects or persons, potentially damaging the objects or harming the persons. Similar dangers exist when removing the steel banding, as the steel banding is typically cut for removal. By cutting the steel banding, tension is suddenly released, which can result in the steel banding to propel outward.

Additionally, steel banding can scratch or tear the objects being bundled or other objects that come into contact with the steel banding. The steel banding can also be susceptible to rust, which may damage or stain the bundled objects or objects coming into contact with the steel banding.

Furthermore, steel banding typically does not stretch. Once steel banding is applied to a load (e.g., a single object, a bundle of several objects, or some other load), the load can settle or shift such that the steel banding is no longer tightly wrapped around the load. This can also result in potential damage and injury.

To alleviate these and other injury and property damage concerns, synthetic strapping (e.g., woven polyester strapping) has been used as an alternate to steel banding, as synthetic strapping is not sharp and typically has similar strength properties as compared to steel banding, but deficiencies in existing tensioning tools have slowed or prevented widespread industry adoption. For example, existing tensioning tools for use with synthetic straps typically provide an insufficient and uneven amount of tension to strapping. Commonly, such tensioning tools are used in conjunction with a buckle, and such tensioning tools typically include a flat base, a single tensioning shaft, and a ratchet and pawl system configured to rotate the tensioning shaft. In practice, a length of strapping is wrapped around a load, a portion of the length of strapping is looped around a first prong of the buckle such that a first end of the length of strapping is extending freely from the buckle, and another portion of the length of strapping is similarly looped around a second prong of the buckle such that a second end of the length of strapping is extending freely from the opposite side of the buckle. The base of the tensioning tool is then positioned between the load (i.e., the object(s) to be bound or bundled) and the length of strapping encircling the load, and the corresponding end (i.e., either the first end or the second end) of the length of strapping is fed through a slot of the tensioning shaft (also called a ratcheting barrel). The shaft is then caused to rotate, such as by a user manually operating the ratchet and pawl system of the tensioning tool. As the shaft of the tensioning tool is rotated and tension is applied to the strap, the prongs of the buckle deform toward the load and apply pressure to the strap to lock the strap in place by frictional forces. Any excess strapping material at the end inserted into the tensioning shaft is cut away, and the base of the tensioning tool is then slid out from between the load and the length of strapping encircling the load.

As can be seen above, existing tensioning tools are configured to tighten the strap from a single end of the length of strapping and from a single side of the buckle. This may provide uneven tension to the buckle, which may fully deform one prong of the buckle without fully deforming the other prong. Thus, existing tensioning tools may not fully secure the strap on both sides of the prong, which may permit the strap to loosen over time or in response to external forces. In turn, loosening of the strap may permit the bundled load to shift, which could ultimately cause damage to the bundled load or neighboring objects and/or injury to nearby persons.

Additionally, as described above, a user must slide out the base of the tensioning tool from between the load and the length of strapping encircling the load to remove the tensioning tool. This may release tension on the strapping and/or the buckle. This is because, during the tensioning process, the length of strapping was wrapped around both the load and the base of the tensioning tool, and once the tensioning tool is removed, the load is permitted additional space within the constraints of the length of strapping (i.e., the space previously filled by the base of the tensioning tool), thus decreasing the tension of the length of strapping. This may permit the bundled load to shift, which could ultimately cause damage to the bundled load or neighboring objects and/or injury to nearby persons.

Further, existing tensioning tools may be particularly susceptible to introducing, upon removal of the tensioning tool from the load, a decrease in tension to the length of strapping when the load has a round or irregular cross-sectional shape. Because existing tensioning tools typically include an extended, flat base, the ends of the flat base may extend tangentially beyond the surface curvature of a round or irregularly-shaped load, creating a void between the edge of the base and the surface of the round object. Thus, when used with loads having a round or irregular cross-sectional shape, existing tensioning tools are required to place tension on a length of strapping when the strapping is encircling the load, the base of the tensioning tool, and the void created between the edges of the tensioning tool and the surface of the round object. Accordingly, upon removal of the tensioning tool, the load is permitted additional space within the constraints of the length of strapping (i.e., the space previously filled by the base of the tensioning tool and the void between the edges of the tensioning tool and the surface of the round object), resulting in an even greater decrease in tension on a round or irregularly-shaped load as compared to a load having a rectangular shaped cross-section. This may, in turn, result in a higher likelihood of the load shifting, which could ultimately cause damage to the bundled load or neighboring objects and/or injury to nearby persons.

### SUMMARY

These and other problems may be addressed by the technology disclosed herein. The disclosed technology can include a tensioning mechanism including an input shaft configured to receive torque and a differential having an input portion connected to the input shaft. The differential can have a first output portion and a second output portion. The first output portion can be located on a first side of the differential, and the second output portion can be located on a second side of the differential that is different from the first side. The first side is opposite the second side. The first output portion can be in mechanical communication with a first worm gear, and the second output portion can be in mechanical communication with a second worm gear. The tensioning mechanism can include a first output gear in mesh with the first worm gear and a second output gear in mesh with the second worm gear.

The torque received at the input shaft can be a first torque having a first force, and the tensioning mechanism can be configured to output a second torque at the first output gear and/or the second output gear, such that the second torque is greater than the first torque.

The tensioning mechanism can include a first tensioning barrel fixedly attached to the first worm gear and a second tensioning barrel fixedly attached to the second worm gear.

The first output gear can be configured to rotate in a first rotational direction, and the second output gear can be configured to rotate in a second rotational direction that is opposite the first rotational direction.

The tensioning mechanism can include a first drive shaft having a first end connected to the first output portion of the differential and a second end connected to the first worm gear. The tensioning mechanism can include a second drive shaft having a first end connected to the second output portion of the differential and a second end connected to the second worm gear.

The first and second drive shafts can be coaxially aligned.

The first output gear can be configured to rotate about a first axis, the second output gear is configured to rotate about a second axis, and the first and second axes can be parallel.

The input shaft can be configured to rotate about a third axis that is perpendicular to the first axis and the second axis.

The first driveshaft can be configured to rotate about a fourth axis, the second driveshaft can be configured to rotate about a fifth axis, and the fourth and fifth axes can be perpendicular to each of the first, second, and third axes.

The fourth axis can be parallel to the fifth axis.

The tensioning mechanism can include a motor configured to selectively apply torque to the input shaft.

The tensioning mechanism can include a controller configured to transmit instructions to the motor.

The disclosed technology can include a tensioning mechanism including an input shaft configured to receive torque, a first worm gear in mechanical communication with the input shaft via at least one intermediary gear, and a second worm gear in mechanical communication with the input shaft via the at least one intermediary gear. The tensioning mechanism can include a first output gear in mesh with the first worm gear and a second output gear in mesh with the second worm gear.

The disclosed technology can include a tensioning tool comprising a housing, a system of gears disposed within the housing, and an input shaft in mechanical communication with the system of gears. The tensioning tool can include a first tensioning barrel and a second tensioning barrel, and each tensioning barrel can include a slot configured to receive at least a portion of a length of strapping material and can be in mechanical communication with the system of gears such that torque can be transferred from the input shaft and to either tensioning barrel via the system of gears.

The system of gears can include a differential.

The system of gears can include a worm gear.

The system of gears can include a first worm gear and a second worm gear, and either worm gear can be in mechanical communication with the differential. The system of gears can also include a first output gear in mesh with the first worm gear, and a second output gear in mesh with the second worm gear. The first output gear can be fixedly attached to the first tensioning barrel, and the second output gear can be fixedly attached to the second tensioning barrel.

The first output gear can be configured to rotate in a first rotational direction, and the second output gear can be configured to rotate in a second rotational direction that opposite the first rotational direction.

The housing can comprise a plurality of cutouts.

The tensioning tool can include a handle.

The tensioning tool can include a cutting system, which can include a first cutter housing including a first slot configured to at least partially receive a first portion of a length of strapping, and a second cutter housing including a second slot configured to at least partially receive a second portion of a length of strapping. The cutting system can also include a first cutter at least partially disposed within the first cutter housing, and a second cutter at least partially disposed within the second cutter housing. The first cutter can be configured to rotate within the first cutter housing, and the second cutter can be configured to rotate within the second cutter housing.

The cutting system can include a cutting actuator in mechanical communication with a cutting shaft, and the cutting actuator can be configured to at least partially rotate the cutting shaft. The cutting system can include a first arm in mechanical communication with the cutting shaft and the first cutter, and the first arm can be configured to transmit rotation of the cutting shaft to the first cutter. The cutting system can include a second arm in mechanical communication with the cutting shaft and the second cutter, and the second arm can be configured to transmit rotation of the cutting shaft to the second cutter.

The cutting actuator can be a lever or a button.

The cutters can be disposed on a first side of the housing, and the cutting actuator can be disposed on a second side of the housing that is different from the first side. The second side can be opposite the first side.

The tensioning tool can comprise one or more motors configured to selectively rotate the first tensioning barrel, the second tensioning barrel, the first cutter, and/or the second cutter. The tensioning tool can comprise a controller configured to transmit instructions to the motor.

The first and/or second tensioning barrel is configured to apply tension to a length of strapping and/or a buckle in the range of approximately 500 pound-forces to approximately 800 pound-forces.

The disclosed technology can include a method for bundling a load, and the method can include inserting a first portion of a first end of a length of strapping into a first cutter slot of a first cutter housing of a tensioning tool, inserting a second portion of the first end of the length of strapping into a first barrel slot of a first tensioning barrel of the tensioning tool, inserting a first portion of a second end of the length of strapping into a second cutter slot of a second cutter housing of the tensioning tool, and inserting a second portion of the second end of the length of strapping into a second barrel slot of a second tensioning barrel of the tensioning tool. The method can include applying torque to an input shaft of the tensioning tool, thereby transferring the torque to the first and/or second tensioning barrel via a system of gears included in the tensioning tool, thereby rotating the first and/or second tensioning barrel. The method can include activating a cutting actuator of the tensioning barrel, thereby rotating the first cutter within the first cutter housing and rotating the second cutter within the second cutter housing such that the first cutter cuts the first end from the length of strapping and the second cutter cuts the second end from the length of strapping.

The method can also include wrapping the length of strapping around the load, looping a third portion of the first end around a first prong of a buckle and under a base portion of the buckle, and looping a third portion of the second end around a second prong of a buckle and under the base portion of the buckle.

The step of applying torque to the input shaft may include applying torque to the input shaft until a desired amount of tension is applied to the length of strapping and/or the buckle. The desired amount of tension may be in the range of approximately 500 pound-forces to approximately 800 pound-forces.

### BRIEF DESCRIPTION OF THE FIGURES

Reference will now be made to the accompanying figures, which are not necessarily drawn to scale, and wherein:

FIG. 1 is an isometric view of an example tensioning device, according to the present disclosure;

FIG. 2 is an isometric view of an example tensioning device, according to the present disclosure;

FIG. 3 is an isometric view of an example tensioning device, according to the present disclosure;

FIG. 4 is a component diagram depicting certain components of an example tensioning device, according to the present disclosure;

FIG. 5 is a cross-sectional view of an example tensioning device, according to the present disclosure;

FIGS. 6A and 6B depict a tensioning tool being used to bundle a load, according to the present disclosure; and

FIG. 7 is a flow diagram illustrating an example method of bundling a load, according to the present disclosure.

### DETAILED DESCRIPTION

Throughout this disclosure, various aspects of a tensioning tool are discussed. Such a tensioning tool may be useful for wrapping and/or bundling a load (i.e., one or more objects) with a length of strapping, such as a length of woven synthetic strapping. But the disclosed technology is not so limited. For example, the disclosed technology may be effective for applying tension to any other object or system. As another example, the disclosed technology may be useful in pulling a portion of an object or system away from another portion of the object or system. As yet another example, the disclosed technology may include a tensioning mechanism, which may, as a non-limiting example, be incorporated in a tensioning tool. Alternately or in addition, the tensioning mechanism may be used in any application where bi-directional tension is applied. As will be appreciated, the tensioning mechanism may be a component of machinery. Other applications of the disclosed technology may become apparent to those having skill in the art and are contemplated herein.

The disclosed technology will be described more fully hereinafter with reference to the accompanying drawings. This disclosed technology may, however, be embodied in many different forms and should not be construed as limited to the examples expressly set forth herein. The components described hereinafter as making up various elements of the disclosed technology are intended to be illustrative and not restrictive. Many suitable components that would perform the same or similar functions as components described herein are intended to be embraced within the scope of the disclosed electronic devices and methods. Such other components not described herein may include, but are not limited to, for example, components developed after development of the disclosed technology.

Throughout the specification and the claims, the following terms take at least the meanings explicitly associated herein, unless the context clearly dictates otherwise. The term “or” is intended to mean an inclusive “or.” Further, the terms “a,” “an,” and “the” are intended to mean one or more unless specified otherwise or clear from the context to be directed to a singular form.

Unless otherwise specified, the use of the ordinal adjectives “first,” “second,” “third,” etc., to describe a common object, merely indicate that different instances of like objects are being referred to, and are not intended to imply that the objects so described should be in a given sequence, either temporally, spatially, in ranking, or in any other manner.

As described herein, the disclosed technology relates to a tensioning tool that can be, for example, useful for wrapping and/or bundling a load (i.e., one or more objects) with a length of strapping, such as a length of woven synthetic strapping. The tensioning tool can include dual tensioning shafts, which can each include one or more slots configured to receive a portion of a length of strapping. The dual tensioning barrels may be configured to rotate in opposite directions (i.e., one tensioning barrel rotates clockwise while the other tensioning barrel rotates counter-clockwise). The tensioning tool may include one or more cutter devices, which may be configured to cut away excess strapping after a desired amount of tension has been applied to the strapping. Various aspects and functionalities of the disclosed technology are discussed more fully below.

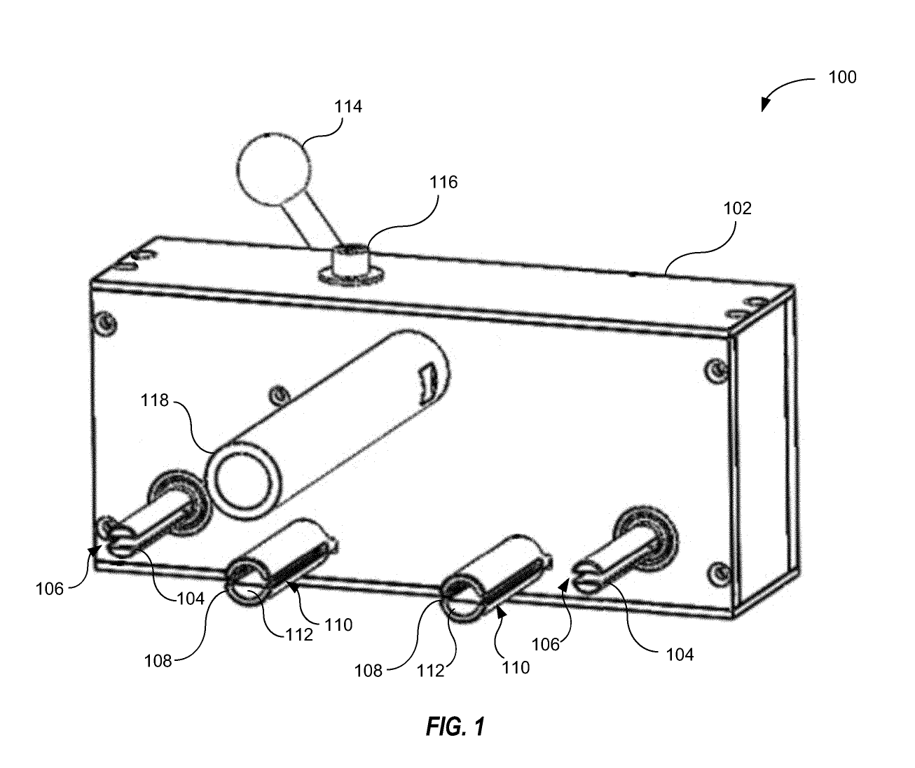

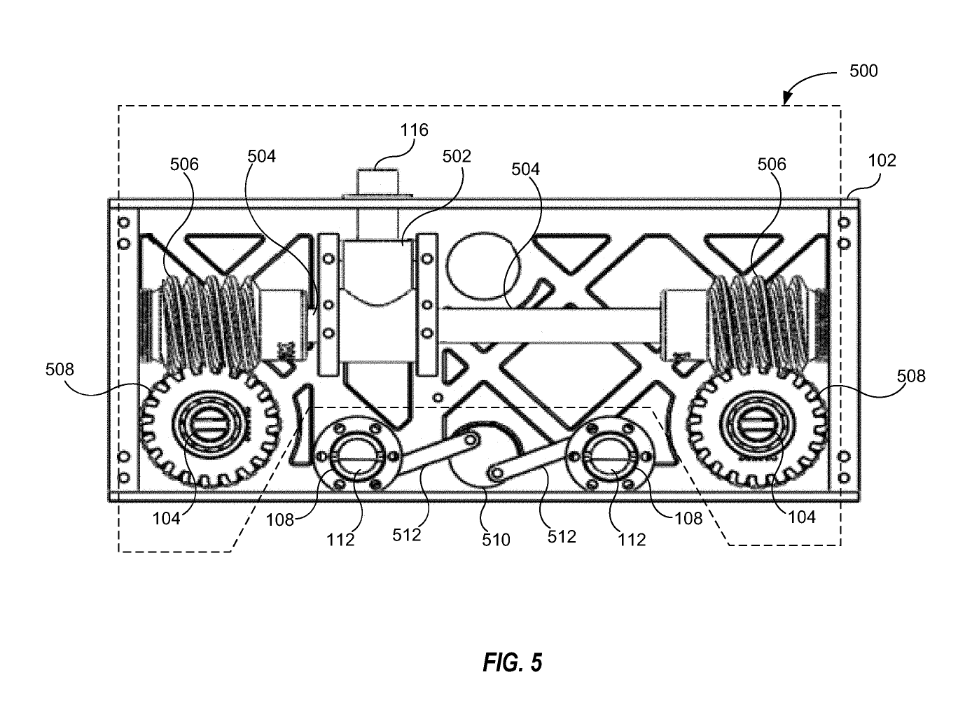

FIG. 1 depicts an example tensioning tool 100, which can include a housing 102 and two tensioning barrels 104 extending outward from a common face of the housing 102. As will be appreciated, the tensioning tool 100 can be a handheld tool. The housing 102 may include one or more cutouts (for example, as shown in FIG. 5), which may decrease the overall weight of the tensioning tool. Either tensioning barrel 104 can include one or more slots 106 configured to receive a portion of a length of strapping. Each slot 106 may extend across the entire diameter of the tensioning barrel 104. FIG. 1 depicts a tensioning barrel 104 include one slot 106, but the tensioning barrel 104 may include two, three, or more slots 106, with each slot 106 extending across the diameter of the tensioning barrel 104 and intersecting at a center point of the tensioning barrel 104. One, some, or all of the tensioning barrels 104 may include a rough finishing on the outer surface of the tensioning barrel 104 to increase friction between the tensioning barrel 104 and the strapping, which may enhance the ability of the tensioning barrel 104 to restrain the strapping as the tensioning barrel 104 rotates and wraps the strapping about the tensioning barrel 104.

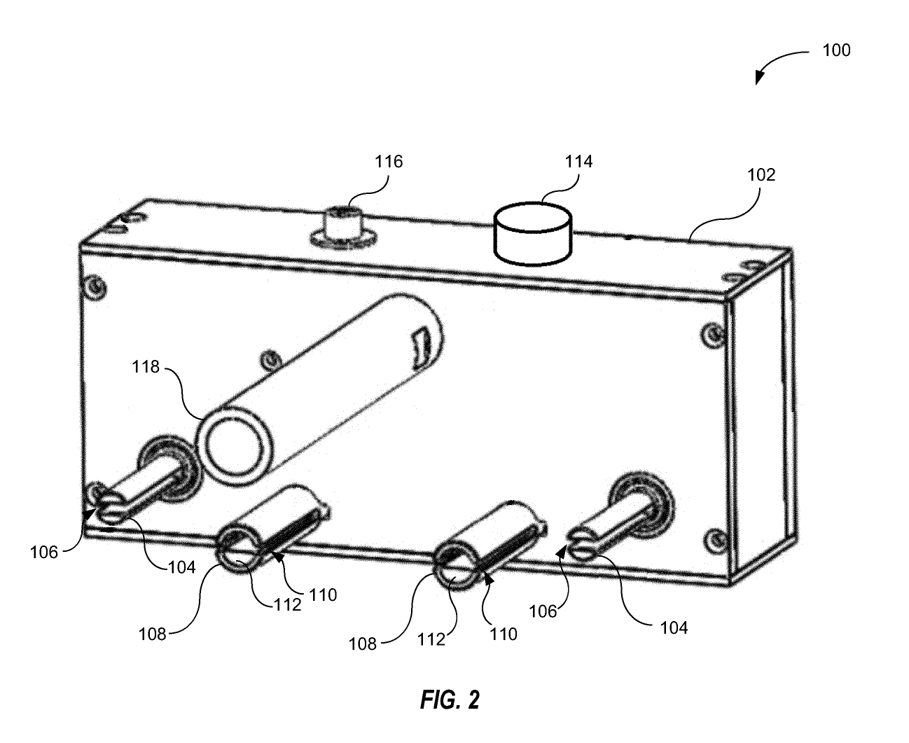

The tensioning tool 100 may include one or more cutter housings 108 and each cutter housing may include a slot 110 and a cutter 112. The slot 110 may be configured to receive a portion of strapping, and the cutter 112 may be configured to rotate within the cutter housing 108 such that the cutter 112 pinches the strapping between an edge of the cutter 112 and an edge of the wall of the cutter housing 108 proximate one end of the slot 110. Thus, the cutter 110 and cutter housing 108 may be configured to cut away excess material from the strapping subsequent to the tensioning tool 100 applying tension to the strapping. The cutter may have a semicircular cross-section. The tensioning tool 100 may include a cutter actuator 114 configured to cause the cutter 108 to rotate within the cutter housing 108. As shown in FIG. 1, the cutter actuator 114 can be a lever. Alternately, as shown in FIG. 2, the cutter actuator 114 can be a button. Alternatively, the cutter actuator may include any other useful mechanical mechanism capable of causing the cutter 108 to rotate within the cutter housing 110 or otherwise causing the cutter 108 to cut away excess strapping. Alternately, the cutter actuator 114 can be an electrical switch (e.g., the button depicted in FIG. 2) and the cutter actuator 114 can be in electrical communication with an electro-mechanical actuator (e.g., an electric motor), configured to selectively engage the cutter 108. The cutter actuator 114 may be disposed away from the cutters 108, which may decrease the likelihood that a user cuts himself or herself during use. For example, the cutter actuator 114 may be disposed on an opposite side of the housing 102 as compared to the cutters 108.

The tensioning tool 100 may include an input shaft 116. The input shaft 116 may be configured to mate with, and receive torque from, a bit or other insert configured to insert into a common drill/driver. The input shaft 116 may, alternately or in addition, be configured to receive torque from a hand crank or some other source of manual torque input. For example, the input shaft 116 may include a nut or bolt (e.g., a hex bolt), that is nonrotatable with respect to the input shaft 116. The bolt which may be configured to mate with a bit that is insertable into a common drill/driver (e.g., a hex nut bit). Thus, a driver or some other external device can rotate the bolt, as well as the input shaft 116.

The tensioning tool 100 may also include one or more handles 118. Each handle 118 may be fixedly mounted to the housing 102. As shown in FIGS. 1-3, the handle 118 may extend perpendicularly from a face of the housing 102. Alternately or in addition, the tensioning tool 100 may include a handle 118 extending parallel to a face of the housing 102, which may be attached to the corresponding face of the housing 102 via one or more brackets, for example. The handle 118 may include a cushioned grip, such as a foam grip, which may increase the ergonomic effect of the handle 118. To further the ergonomic benefits of the tensioning tool 100, the bottom of the housing 102 may include a gripping material or a material with a high coefficient of friction. For example, the bottom of the housing 102 may include one or more pieces of SBR rubber. This may prevent the tensioning tool 100 from slipping when pressed against a load, thereby increasing the ergonomic and safety benefits of the tensioning tool 100. As will be appreciated by those having skill in the art, the low input torque required by the tensioning tool 100 may provide a minimal reaction force that in turn may require little stabilizing force on the part of a user when torque is being applied to the input shaft 116.

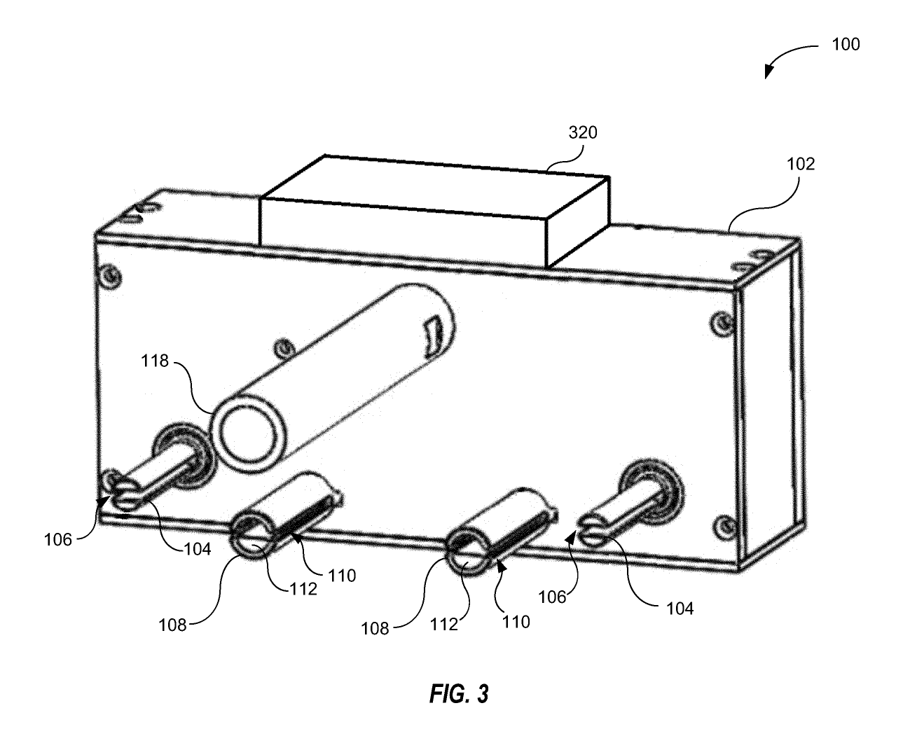

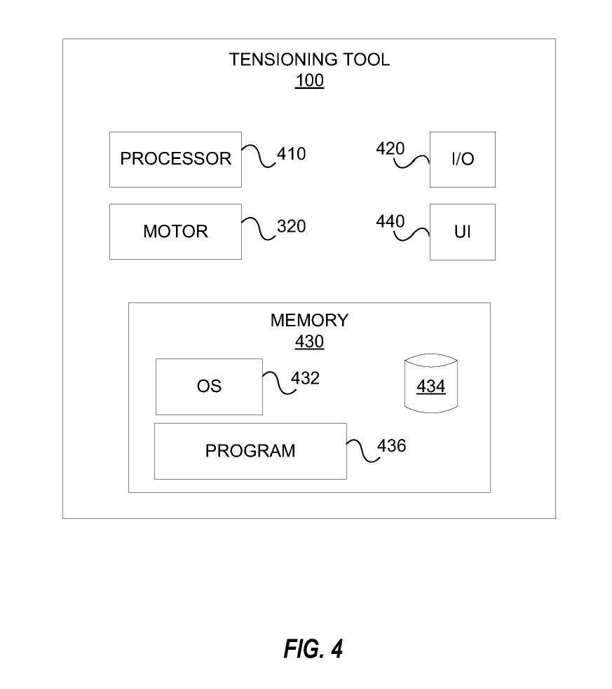

Referring to FIG. 3, the tensioning tool 100 may include a motor 320, such that an external device is not required to rotate the tensioning barrels 104 and/or the cutters 112. The motor 320 may be contained within a motor housing, or the motor 320 may be included in the housing 102 of the tensioning tool 100. As shown in FIG. 4, the tensioning tool 100 may include a processor 410, an input/output (I/O) device 420, memory 430, and/or a user interface (UI) device 440 for receiving user input data, such as data representative of a click, a scroll, a tap, a press, or typing on an input device that can detect tactile inputs. The UI device 440 may include the cutter actuator 114. Memory 130 may store one or more of an operating system (OS) 432, a database 434, which may be any suitable repository of data, and a program 436. The program 436 may be configured to cause the processor to transmit signals to the motor such that the processor can control the motor 320, such as on/off, torque, and/or speed of the motor 320, such that the motor 320 can cause one or more of tensioning barrels 104 to rotate. The processor 410 may be in electrical communication, and capable of communicating with the motor 320 or another motor to control the cutters 112. One of ordinary skill will recognize that these are merely examples, and the tensioning tool 100 may not include all the depicted elements of FIG. 4, and/or may include various additional or alternative elements.

FIG. 5 is a cross-sectional view depicting a tensioning mechanism 500 (e.g., the internal components of the tensioning tool 100). As described above, the tensioning mechanism 500 can be, but is not necessarily required to be, incorporated in the tensioning tool 100. The tensioning mechanism 500 may include the input shaft 116, which may be in mechanical communication with an input portion differential 502 or some other set of gears capable of evenly, or substantially evenly, distributing the input torque received via the input shaft 116 to one or more drive shafts 504. (FIG. 5 depicts two drive shafts 504.) The differential can include an input portion configured to receive torque (e.g., via the input shaft 116) and can include one or more output portions, such as two output portions. Each output portion can be connected to a drive shaft (e.g., drive shaft 504) or some other rotating member. If two or more drive shafts 504 are included, the differential 502 may be configured to rotate the drive shaft 504 with the least resistance until both drive shafts have a substantially equal resistance, at which time the differential is configured to rotate both drive shafts 504 at an equal, or substantially equal, torque and/or speed. Each drive shaft 504 may be mechanically coupled to a transition gear 506, such as a worm gear. Worm gears may be configured to self-lock such that the worm gear cannot spin in reverse due to, for example, torque created from tension in the strapping, even if the input of torque through the input shaft 116 is paused or stopped. Further, worm gears may provide a high gear ratio, which may enable the tensioning tool 100 to have a low torque input and a comparatively high torque output. For example, the tensioning tool 100 may be configured to output tension in strapping via one or both tensioning barrels 104 in the range of approximately 500 pound-forces (lbf) to approximately 800 pound-forces. As will be appreciated, other gears may be used, depending on, for example, the desired size, geometry, and relative positioning of the various components of the tensioning tool 100. Each transition gear 506 can mesh with a corresponding output gear 508, such that the tensioning mechanism 500 can output tension to one or more desired objects. The tensioning mechanism 500 may include any number of additional gears (e.g., 1, 2, 3, 4, 5, 6, 10, 20), which may be useful to alter alignment and/or positioning of various shafts, output gears, or other components. Alternately or in addition, additional gears may be useful to alter rotation direction, torque, or speed of one or more components of the tensioning mechanism. One of ordinary skill will recognize that these are merely examples, and the tensioning mechanism 500 may not include all the depicted elements of FIG. 5, and/or may include various additional or alternative elements. As will be appreciated, the tensioning tool 100 can incorporate tensioning mechanism, and each output gear 508 can be mechanically coupled to a corresponding tensioning barrel 104, which may extend out of the housing 102, as shown in FIGS. 1-3.

A cutting shaft 510 may be in mechanical communication with cutting actuator 114, such as the lever depicted in FIG. 1. The cutting shaft 510 may also be pivotally connected to one or more arms 512, and each arm 512 may be connected to a corresponding cutter 108. Thus, as the cutting actuator 114 (e.g., a lever) causes the cutting shaft 510 to rotate, the rotation is transmitted to one or more cutters 108 via one or more respective arms 512.

The various components and subcomponents of the tensioning tool 100 and/or tensioning mechanism 500 may be of metal or plastic. For example, one, some, or all of the components described herein may be made of copper, bronze, steel, aluminum, or any alloy thereof. As another example, one, some, or all of the components described herein may be made of polyethylene, polypropylene, polyvinyl chloride, or any other useful plastic.

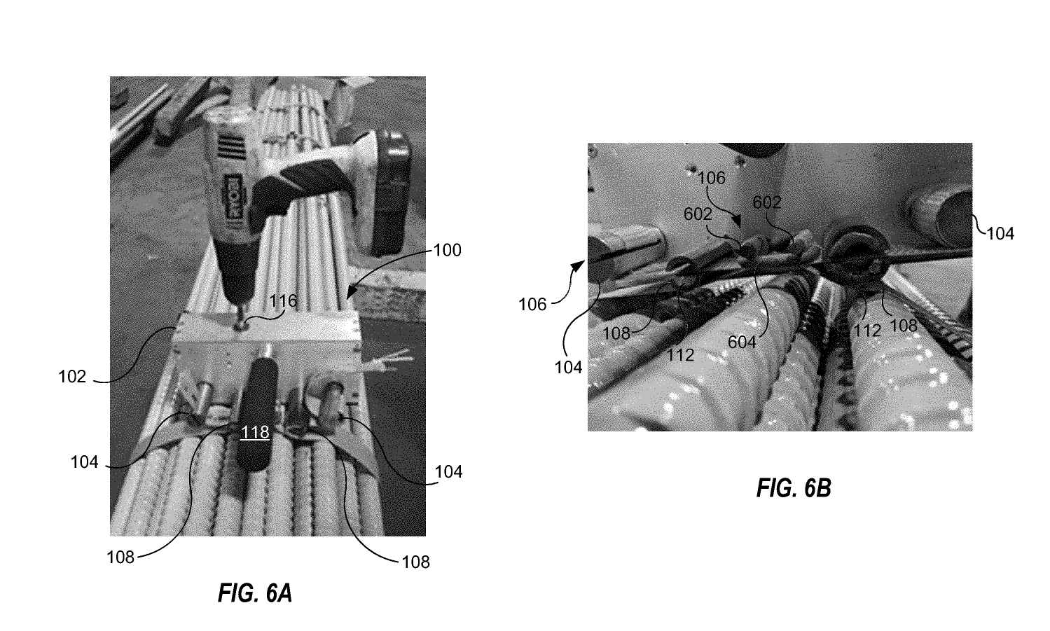

FIGS. 6A and 6B show the tensioning tool 100 being used to bundle a load, and more particularly to bundle together several elongate steel rods. As shown most clearly in FIG. 6B, a length of strapping is wrapped around the steel rods and looped around two opposite prongs 602 of a buckle 600. Either end of the length of strapping extends around a prong 602 of the buckle 600, under a base portion 604 of the buckle 600, through a slot 110 of the cutter housing 108, and through a slot 106 of a tensioning barrel 104. Torque can be applied to the input shaft 116 (e.g., by a drill or driver, as shown in FIG. 6A), and that torque can be transferred via the internal gearing of the tensioning tool 100, to the tensioning barrels 104, causing the tensioning barrels 104 to rotate. As either tensioning barrel 104 rotates, tension is applied to the strapping, pulling the corresponding prong 602 toward the base portion 604, thereby pulling the strapping taut about the load (e.g., the steel rods) and crimping, pinching, or otherwise restraining by friction a portion of the strapping between the prong 602 and the base portion 604. That is, as tension is applied to the strapping, the tension causes the prongs 602 of the buckle 600 to deform and apply pressure to the strapping, thereby locking by friction forces the strapping in place between the prongs 602 and the base portion 604. As can be seen from FIG. 6B, the tensioning tool 100 is configured to apply tension to the strapping and close the buckle 600 without requiring a base plate or any other portion of the of the buckle 600 to be positioned between the load and the portion of the strapping being pulled taut about the load. Thus, the tensioning tool 100 may be configured to apply tension to a load without necessarily reducing that tension upon removal of the tensioning tool 100, as is typically the case with existing devices.

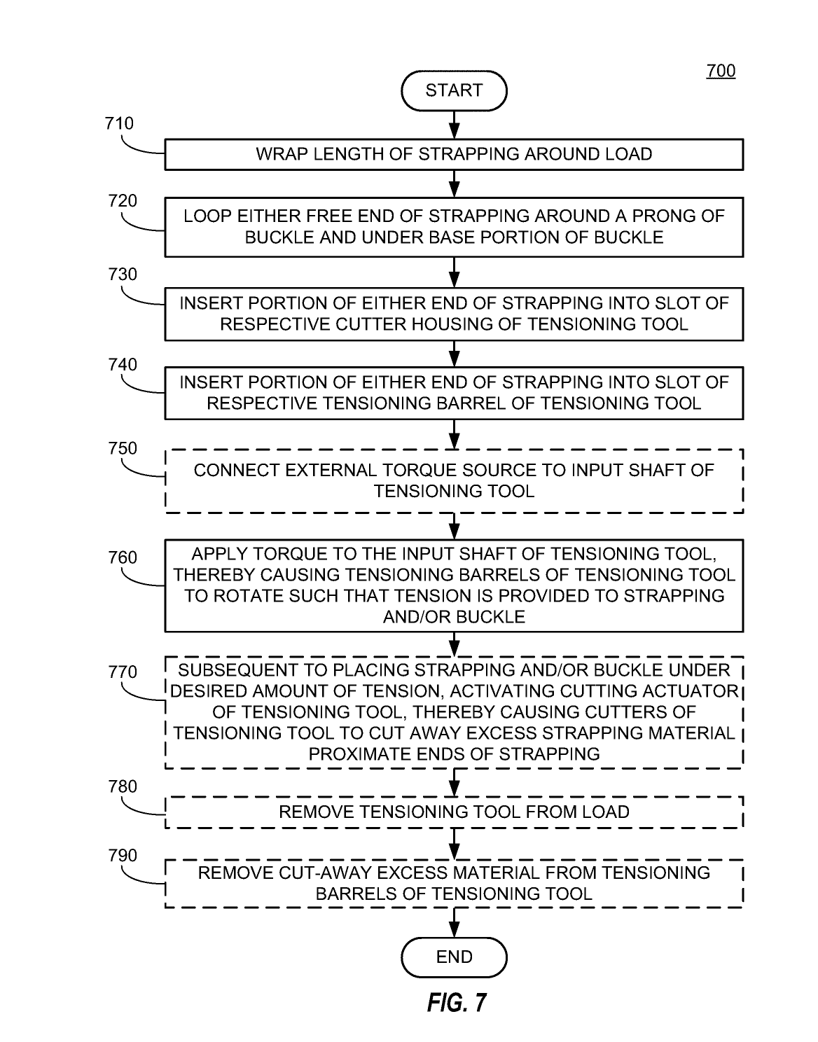

Referring to FIG. 7, a flowchart depicting an example method 700 for applying strapping to a load is provided. The method 700 may be performed using some or all of components, subcomponents, and/or functionalities of the tensioning tool 100.

The method 700 can include wrapping 710 a length of strapping around a load and looping 720 either free end of the length of strapping around a respective prong 602 of a buckle 600 and under a base portion 604 of the buckle 602. The method 700 can include inserting 730 a portion of either end of the length of strapping into a slot 110 of a respective cutter housing 108 of the tensioning tool 100 and inserting 740 a portion of either end of the length of strapping into a slot 106 of a respective tensioning barrel 104 of the tensioning tool 100. The method 700 may or may not include connecting 750 an external torque source (e.g., a drill/driver) to an input shaft 116. The method 700 can include applying 760 torque to the input shaft 116. Applying 760 torque to the input shaft 116 can cause torque to be transferred from the input shaft 116 and to the tensioning barrels 104 via a system of gears (e.g., differential 502, transition gear 506, output gear 508) included in the tensioning tool 100. As will be appreciated, the transfer of torque to the tensioning barrels 104 will cause the tensioning barrels 104 to rotate such that either end of the length of strapping is wound about the outer surface of the respective tensioning barrel, placing tension on the length of strapping and/or the buckle 600. Torque can be applied 760 to the input shaft 116 until the tensioning barrels 114 have placed the length of strapping and/or the buckle under a desired amount of tension. The method 700 include, subsequent to placing, via the tensioning barrels 114, the length of strapping and/or the buckle under a desired amount of tension, activating 770 the cutting actuator 114. Activating 770 the cutting actuator 114 can cause the cutters 112 to cut away excess strapping material proximate the ends of the length of strapping. The method 700 may or may not include removing 780 the tensioning tool 100 from the load and may or may not include removing 790 the cut-away excess strapping material from the tensioning barrels 104.

While the disclosed technology has been described in connection with what is presently considered to be the most practical designs, it is to be understood that the disclosed technology is not to be limited to the disclosed designs, but on the contrary, is intended to cover various modifications and equivalent arrangements included within the scope of the appended claims. Although specific terms are employed herein, they are used in a generic and descriptive sense only and not for purposes of limitation.

What is claimed is:

1. A tensioning mechanism comprising:
an input shaft configured to receive torque; and
a differential having an input portion connected to the input shaft, a first output portion, and a second output portion.

2. The tensioning mechanism of claim 1, wherein the torque received at the input shaft is a first torque having a first force and the tensioning mechanism is configured to output a second torque that is greater than the first torque.

3. The tensioning mechanism of claim 1, wherein the first output portion is located on a first side of the differential and the second output portion is located on a second side of the differential, the first side being different from the second side.

4. The tensioning mechanism of claim 3, wherein the first side is opposite the second side.

5. The tensioning mechanism of claim 1 further comprising:
a first worm gear in mechanical communication with the first output portion and in mesh with a first output gear; and
a second worm gear in mechanical communication with the second output portion and in mesh with a second output gear.

6. The tensioning mechanism of claim 5 further comprising a first tensioning barrel fixedly attached to the first output gear and a second tensioning barrel fixedly attached to the second output gear.

7. The tensioning mechanism of claim 5, wherein the first output gear is configured to rotate in a first rotational direction and the second output gear is configured to rotate in a second rotational direction that is opposite the first rotational direction.

8. The tensioning mechanism of claim 5 further comprising:
a first drive shaft having a first end connected to the first output portion of the differential and a second end connected to the first worm gear; and
a second drive shaft having a first end connected to the second output portion of the differential and a second end connected to the second worm gear.

9. The tensioning mechanism of claim 8, wherein the first and second drive shafts are coaxially aligned.

10. The tensioning mechanism of claim 5, wherein the first output gear is configured to rotate about a first axis and the second output gear is configured to rotate about a second axis, the first and second axes being parallel.

11. The tensioning mechanism of claim 10, wherein the input shaft is configured to rotate about a third axis that is perpendicular to the first axis and the second axis.

12. The tensioning mechanism of claim 11, wherein the first driveshaft is configured to rotate about a fourth axis and the second driveshaft is configured to rotate about a fifth axis, the fourth and fifth axes being perpendicular to each of the first, second, and third axes.

13. The tensioning mechanism of claim 12, wherein the fourth axis can be parallel to the fifth axis.

14. The tensioning mechanism of claim 1 further comprising a motor configured to selectively apply torque to the input shaft.

15. The tensioning mechanism of claim 14 further comprising a controller configured to transmit instructions to the motor.

16. A tensioning mechanism comprising:
an input shaft configured to receive torque;
a first worm gear in mechanical communication with the input shaft via at least one intermediary gear;
a second worm gear in mechanical communication with the input shaft via the at least one intermediary gear; and
a first output gear in mesh with the first worm gear and a second output gear in mesh with the second worm gear.
